(19) United States
(12) Patent Application Publication
(10) Pub. No.: US 2014/0214497 A1
(43) Pub. Date: Jul. 31, 2014

(54) SYSTEM AND METHOD FOR ENSURING TIMING STUDY QUALITY IN A SERVICE DELIVERY ENVIRONMENT

(71) Applicant: INTERNATIONAL BUSINESS MACHINES CORPORATION, Armonk, NY (US)

(72) Inventors: Gargi B. Dasgupta, Gurgaon (IN); Nirmit V. Desai, Bangalore (IN); Yixin Diao, White Plains, NY (US); Aliza R. Heching, Bronx, NY (US)

(73) Assignee: International Business Machines Corporation, Armonk, NY (US)

(21) Appl. No.: 13/751,711

(22) Filed: Jan. 28, 2013

(51) Int. Cl. G06Q 10/06

(52) U.S. Cl. CPC G06Q 10/06395
USPC 705/7.41

(57) ABSTRACT

A system for ensuring timing study quality in a service delivery environment, comprises a participation module capable of determining a level of participation by assets in the timing study, a volume module capable of comparing effort data volume with workload data volume, and a records module capable of analyzing effort data for a duration for each record, wherein one or more of the modules are implemented on a computer system comprising a memory and at least one processor coupled to the memory.

### TECHNICAL FIELD

The field generally relates to systems and methods for ensuring timing study quality and, in particular, to interactive and metric-based systems and methods for ensuring timing study quality in a service delivery environment.

### BACKGROUND

Service delivery can refer to proactive services that are delivered to provide adequate support to business users. Services may be provided from a variety of sources, including but not limited to, Internet and network service providers, and may include general business services, such as, for example, accounting, payroll, data management, and computer type services, such as, for example, information technology (IT) and cloud services. A service delivery environment includes, for example, assets with different attributes relating to the delivered services, such as, for example, equipment with particular functionality, a team of agents with one or multiple skills, etc., wherein the assets provide services to support the customers' requests.

A service delivery group or organization utilizing its assets typically strives to meet defined service-level targets, including, for example, response time, or the time taken to diagnose and solve a problem. In addition, service delivery organizations attempt to find a service solution which meets an objective, such as, for example, minimum cost or maximum profit, which can include minimizing asset costs and attempting to reduce or eliminate missed targets.

In an attempt to ensure that service delivery organizations are operating efficiently, timing studies are performed to analyze asset effort data. Effort data may include, for example, details on the fulfillment of a service request, implementation of a change, solving a problem or addressing an alert, such as how much time an asset spends to complete a task. Timing studies and collection of effort data are also performed to develop service delivery environment simulation models, which may be used when analyzing service delivery environments and the assets thereof.

In order to ensure quality of the timing study results, it is necessary that the collected data be complete and properly collected. Conventional methods for collecting effort data, such as, shadowing or observing and statistical analysis do not adequately ensure quality of the data collected. For example, shadowing or observing asset performance can be costly and difficult to utilize in high volume situations. Statistical analysis, for example, looking at mean, standard deviation, and outliers, may ignore certain contexts in which the data was collected, so that the results are not necessarily true to a specific situation.

Accordingly, there exists a need for a solution which ensures the quality of data collected for the timing studies so that effort data of assets can be properly analyzed.

### SUMMARY

In general, exemplary embodiments of the invention include systems and methods for ensuring timing study quality and, in particular, to interactive and metric-based systems and methods for ensuring timing study quality in a service delivery environment.

According to an exemplary embodiment of the present invention, a system for ensuring timing study quality in a service delivery environment, comprises a participation module capable of determining a level of participation by assets in the timing study, a volume module capable of comparing effort data volume with workload data volume, and a records module capable of analyzing effort data for a duration for each record, wherein one or more of the modules are implemented on a computer system comprising a memory and at least one processor coupled to the memory.

The participation module may process the effort data to determine a participation rate, which is a number of assets providing the effort data divided by a total number of assets.

If the participation rate is less than 100 percent, the participation module may identify those assets which do not provide effort data.

The participation module may process the effort data to determine a number of task records for each asset over a period of time, and may identify if the number of task records is less than a first predetermined value or greater than a second predetermined value.

The participation module may process the effort data to determine a number of hours worked by each asset over a period of time, and may identify if the number of hours worked is less than a first predetermined value or greater than a second predetermined value.

The volume module may determine that the workload volume is not equal to the effort data volume.

The records module may analyze the effort data in connection with timing study guidelines, and may determine if a record duration is less than a first predetermined time or greater than a second predetermined time.

According to an exemplary embodiment of the present invention, a method for ensuring timing study quality, comprises determining a level of participation by assets in the timing study, comparing effort data volume with workload data volume, and analyzing effort data for a duration for each record, wherein one or more steps of the method are performed by a computer system comprising a memory and at least one processor coupled to the memory.

The method may further comprise processing the effort data to determine a participation rate, which is a number of assets providing the effort data divided by a total number of assets. If the participation rate is less than 100 percent, the method may further comprise identifying those assets which do not provide effort data.

The method may further comprise processing the effort data to determine a number of task records for each asset over a period of time, and identifying if the number of task records is less than a first predetermined value or greater than a second predetermined value. If the number of task records is less than the first predetermined value or greater than the second predetermined value, the method may further comprise checking at least one of whether there is a problem with the level of participation or whether there is a problem with the data collection.

The method may further comprise processing the effort data to determine a number of hours worked by each asset over a period of time, and identifying if the number of hours worked is less than a first predetermined value or greater than a second predetermined value. If the number of hours worked is less than the first predetermined value or greater than the second predetermined value, the method may further comprise checking at least one of whether there is a problem with the level of participation or whether there is a problem with the data collection.

The method may further comprise determining that the workload volume is not equal to the effort data volume, wherein if the workload volume is less than the effort data volume, the method may further comprise querying whether more than one timing entry is being generated for one ticket. If the workload volume is greater than the effort data volume, the method may further comprise querying at least one of whether all tickets are being captured or whether one record is being generated for more than one ticket.

The method may further comprise analyzing the effort data in connection with timing study guidelines.

The method may further comprise determining if a record duration is less than a first predetermined time or greater than a second predetermined time, wherein if the record duration is less than the first predetermined time, the method may further comprise querying whether a record is a test record. If the record duration is greater than the second predetermined time, the method may further comprise querying whether the duration corresponds to actual time spent doing work.

According to an exemplary embodiment of the present invention, an article of manufacture comprises a computer readable storage medium comprising program code tangibly embodied thereon, which when executed by a computer, performs method steps for ensuring timing study quality, the method steps comprising determining a level of participation by assets in the timing study, comparing effort data volume with workload data volume, and analyzing effort data for a duration for each record.

According to an exemplary embodiment of the present invention, an apparatus for ensuring timing study quality, comprises a memory, and a processor coupled to the memory and configured to execute code stored in the memory for determining a level of participation by assets in the timing study, comparing effort data volume with workload data volume, and analyzing effort data for a duration for each record.

These and other exemplary embodiments of the invention will be described or become apparent from the following detailed description of exemplary embodiments, which is to be read in connection with the accompanying drawings.

### BRIEF DESCRIPTION OF THE DRAWINGS

Exemplary embodiments of the present invention will be described below in more detail, with reference to the accompanying drawings, of which:

FIG. 1 is a high-level diagram of a system for ensuring timing study quality in a service delivery environment according to an exemplary embodiment of the invention.

FIG. 2 is a screen shot showing effort data according to an exemplary embodiment of the invention.

FIG. 3 is a screen shot showing a participation quality check template according to an exemplary embodiment of the invention.

FIG. 4 is a screen shot showing a volume quality check template according to an exemplary embodiment of the invention.

FIG. 5 is a screen shot showing a records quality check template according to an exemplary embodiment of the invention.

FIG. 6 is a screen shot showing a quality check template according to an exemplary embodiment of the invention.

FIG. 7 is a workflow diagram illustrating a method for ensuring timing study quality in a service delivery environment according to an exemplary embodiment of the invention.

FIG. 8 is a flow diagram illustrating a method for ensuring timing study quality in a service delivery environment according to an exemplary embodiment of the invention.

FIG. 9 illustrates a computer system in accordance with which one or more components/steps of the techniques of the invention may be implemented, according to an exemplary embodiment of the invention.

### DETAILED DESCRIPTION OF EXEMPLARY EMBODIMENTS

Exemplary embodiments of the invention will now be discussed in further detail with regard to interactive and metric-based systems and methods for ensuring timing study quality in a service delivery environment. This invention may, however, be embodied in many different forms and should not be construed as limited to the embodiments set forth herein.

Assets as used herein can refer to any asset or set of assets, and configurations thereof, that are used to contribute to delivering a service and/or responding to one or more service requests. Assets may have one or more attributes that are used to meet the needs of a customer requiring a service and/or response to a service request. For example, assets may include computer applications and application attributes, e.g., a payroll function; equipment and attributes of equipment capability related to the service; a knowledge-base with particular attributes (e.g., search index); and/or a staffing configuration, which is a configuration of service agents for delivering one or more of such services and/or responding to one or more service requests. A configuration of assets can include one or more assets of different types with different attributes used to deliver the requested services and/or responses.

Embodiments of the present invention address the challenges that may be associated with timing study data collection in a service delivery environment. Such challenges may include, for example, diversity of the data being collected and diversity of the assets. For example, assets may be in different groups, have different attributes, such as, for example, skill levels, functionality, performance capabilities, and may be in different geographic locations. In addition, the type of work may vary based on the problems and service requests which require the attention of the assets. For example, assets may need to address downed servers, installation of new equipment and applications, administrative requests, such as forgotten usernames and passwords, alerts, such as maximum or close to maximum utilization of memory or a CPU, and non-ticket work, such as meetings, education, training, asset servicing and repair, etc.

It is noted that the embodiments of the present invention are not necessarily limited to the service delivery environment, and may be applied to any environment where timing study may be needed, such as, for example, any environment where work orders or claims might be processed.

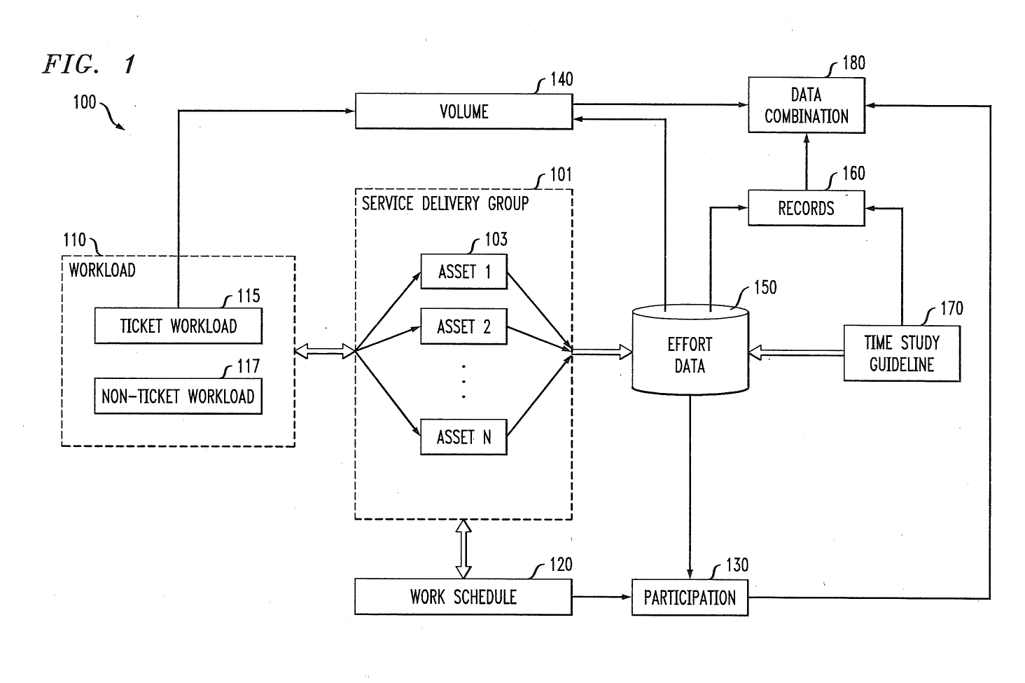

Referring to FIG. 1, which is a high-level diagram of a system for ensuring timing study quality in a service delivery environment, according to an embodiment of the present invention, the system 100 includes a service delivery group module 101, a workload module 110, a work schedule module 120, a participation module 130, a volume module 140, an effort data module 150, a records module 160, a timing study guideline module 170 and a data combination module 180. According to an embodiment, the service delivery group module 101 interacts with workload and work schedule modules 110 and 120 to process workload and work schedule data in connection with each asset 103 and correspond the appropriate workload and work schedule data to the respective assets 103 in the service delivery group. According to an embodiment, the work schedule data includes, for example, the shifts and locations of an asset, and the work schedule data for each asset 103 of a service delivery group is output from the work schedule module 120 to a participation module 130.

According to an embodiment, the workload data can be divided into ticket workload 115 and non-ticket workload 117. The ticket workload 115 comprises ticket work mentioned above, such as, for example, addressing downed servers, installing new equipment and applications, responding to administrative requests and alerts, etc. The non-ticket workload 117 comprises non-ticket work mentioned above, such as meetings, education, training, asset servicing and repair, etc. The ticket and non-ticket workloads 115, 117 can be defined in terms of the number of items of ticket work and non-ticket work per time period, such as, for example, the number of ticket or non-ticket items per week. The workload module 110 together with the service delivery group module 101, processes the workload data 115, 117 in connection each asset 103 to correspond the appropriate workload data to the respective assets 103 in the service delivery group. The ticket workload data 115 for each asset 103 of a service delivery group is output from the workload module 110 to a volume module 140.

Alternatively, according to an embodiment, the service delivery group module 101 can supply the workload and work schedule modules 110 and 120 with data indicating which assets 103 are in a service delivery group, and the workload and work schedule modules can respectively process the workload data 115 and 117, and work schedule data in connection each asset 103 to correspond the appropriate workload and work schedule data to the respective assets 103 in the service delivery group. In another embodiment, workload and work schedule data input to the workload and work schedule modules 110 and 120 can be previously corresponded to the respective assets 103 prior to input to the workload and work schedule modules 110 and 120.

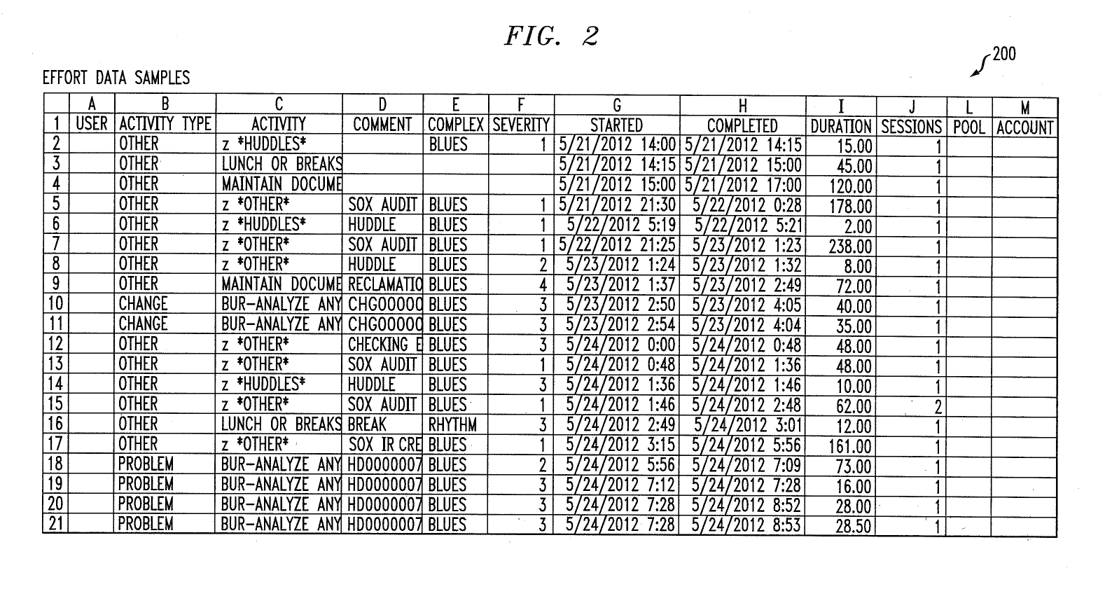

Effort data for each asset 103 in a service delivery group is collected and input to an effort data module 150. Referring to FIG. 2, which is a screen shot 200 showing effort data collected in accordance with an embodiment of the present invention, effort data is data recorded by or for each asset for analysis in a timing study, and reflects services performed by a particular asset. The effort data includes, but is not necessarily limited to, an identification of the asset (e.g., username, equipment name), the activity type (e g., implementing a change, solving a problem, etc.), the activity performed (e.g., analysis, conference, break), complexity, severity, start and completion times, duration of performance, number of sessions, asset pool to which asset is assigned, account worked on, and comments. According to an embodiment, the effort data can be supplied to the effort data module 150 from the service delivery group module 101 or independent of the service delivery group module 101. According to an embodiment, the effort data supplied to effort data module 150 can be categorized to reflect the data layout in FIG. 2, or some other data layout. Alternatively, the effort data module 150, alone, or in combination with the service delivery group module 101 can process effort data into predetermined categories. The processed effort data is then supplied from the effort data module 150 to the participation module 130, the volume module 140 and the records module 160.

According to embodiments of the present invention, the participation, volume and records modules 130, 140 and 160 analyze relevant portions of the effort data, e.g., performance indicators of participation, volume and records, to determine whether the effort data is being properly collected and will result in accurate timing study results. These performance indicators quantify effort data quality, and data quality problems can be identified by analyzing these performance indicators. The results of the identification can guide service delivery entities when fixing the data quality problems, and allow for certification that sufficient quality data has been collected.

The participation module 130 processes the effort data from the effort data module 150 to determine a participation rate, which is the number of assets participating (i.e., providing effort data) divided by the total number of assets in the service delivery group. The participation module also takes into consideration the work schedule data from the work schedule module 120 to discount those assets who did not provide effort data due to, for example, sickness, malfunction, vacation, scheduled maintenance, training, etc. According to an embodiment, if participation is less than 100% of the assets, then the participation module 130 queries whether any assets can be discounted. According to an embodiment, assets that are remote from the data collection site are not discounted.

According to an embodiment, if the participation rate is less than 100%, the participation module 130 identifies those assets which do not provide effort data. Then, an investigation(s) is performed to determine if there is a data quality issue. If there is a data quality issue, action is taken to bring the participation rate to 100 percent. In other words, the effort data is gathered from the assets which did not provide effort data, but were required to provide effort data under the circumstances.

The participation module 130 also processes the effort data to determine a number of task records for each asset over a period of time, for example, the number of records per day, and the number of hours worked by each asset over a period of time, for example, the number of hours worked per day. According to an embodiment, more than one record can be created for a particular ticket item, each record comprising a task that is performed to complete the ticket item. In this case, a ticket item can refer to, for example, a work order and/or a service request. As an example, two records of 1 hour each may be created where a 15 minute break was taken in between each hour. Further, a record can be created for each task that is performed to complete the ticket item.

According to embodiment, if the number of records and/or hours is less than a predetermined value or greater than another predetermined value, a potential problem with the effort data is identified. For example, according to an embodiment, in the case of a service agent, the participation module 130 may identify a potential problem if the number of records per day is less than 2, or greater than 20. In the case of the records per day being less than 2, there can be a question of adequate participation in the data collection, and in the case of the records per day being greater than 20, there can be a question of whether the data collection is being effectively performed. In addition, according to an embodiment, in the case of a service agent, the participation module 130 may identify a potential problem if the number of hours worked per day is less than 2, or greater than 12. In the case of the hours per day being less than 2, there can be a question of adequate participation in the data collection, and in the case of the hours per day being greater than 12, there can be a question of whether the data collection is accurate.

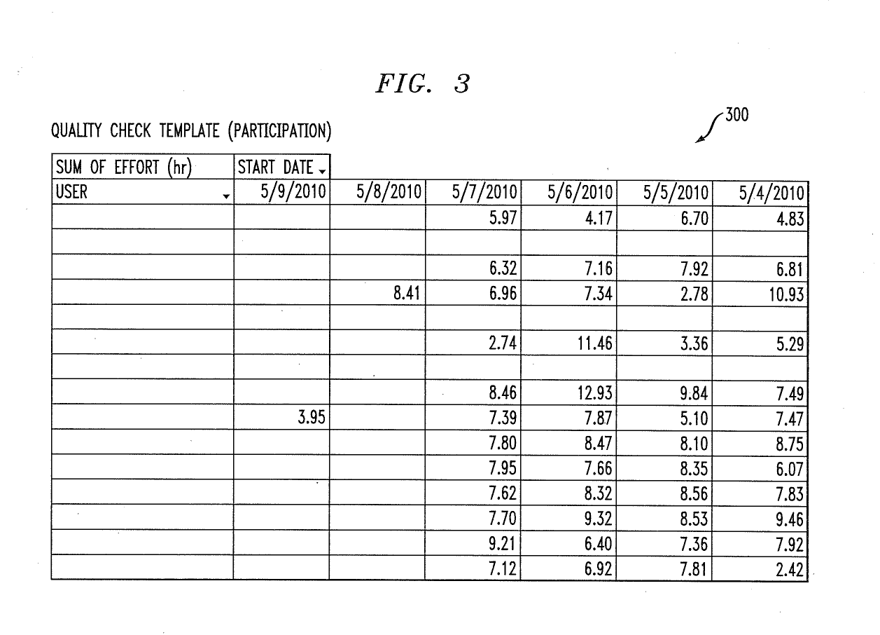

Referring to FIG. 3, according to an embodiment, the results of these participation queries are then tabulated by the participation module into a participation quality check template. In the case of template 300, effort hours per day are tabulated for each asset. Other templates may be generated, for example, templates showing records per day for each asset, or a group of assets, and/or specifying different time periods or ranges.

In connection with the ticket workload, the volume module 140 compares the effort data volume from the effort data module 160 with the ticket workload data 115 from the workload module 110 to determine if the actual workload volume (e.g., 100 tickets) is equal to the effort data volume (e.g., effort data recorded on 100 tickets). If the workload volume is not equal to the effort data volume, and the effort data volume<workload volume, a query is performed to check if all of the tickets are being captured by the data collection and/or if one record is being generated for multiple tickets (e.g., batching similar tickets). Conversely, if the effort data volume>workload volume, a query is performed to check if one ticket is being captured as one timing entry, (e.g., are multiple entries mistakenly being generated for the same ticket?).

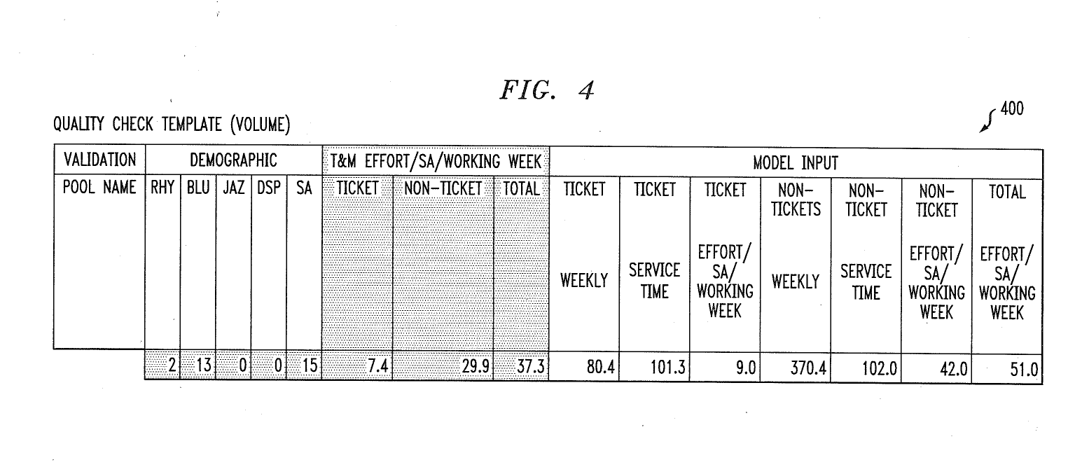

Referring to FIG. 4, according to an embodiment, the results of these volume queries are then tabulated by the volume module into a volume quality check template 400, which reports for a pool of assets whether effort data volume is not consistent with workload volume. For example, referring to the bottom row and the 7^{th} and 12^{th} columns, the effort data volume is 7.4 and the workload volume is 9.0, showing an inconsistency. Other templates may be generated, for example, templates showing data for each individual asset, and/or specifying different time periods or ranges.

The records module 160 analyzes the effort data for the indicated duration for each record in connection with timing study guidelines 170 received from a timing study guideline module 170. The timing study guideline module 170 includes data on a service delivery entity's guidelines for record keeping. If the record data is not in line with the timing study guidelines, the records module 160 indicates a potential problem with record keeping. For example, according to an embodiment, if a record duration is less than a particular time (e.g., less than one minute), or greater than a particular time (e.g., greater than 8 hours) a potential problem may be raised that record keeping is not being properly performed. For example, if tasks are broken up into overly minute or overly large elements, collection of data, and resulting analysis may not be accurate. For example, in the case of an overly large duration block, it may not be a realistic scenario where an asset works without breaks over a time period of a particular length. According to an embodiment, the records module 160 can compare the duration indicated in the records with average duration standards in a timing study guideline.

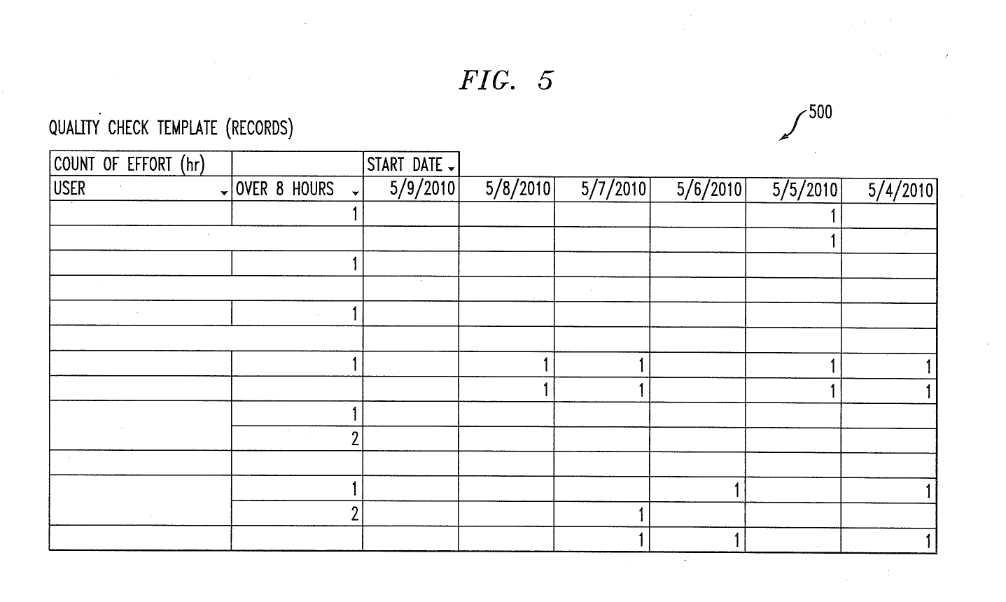

Referring to FIG. 5, according to an embodiment, the results of these volume queries are then tabulated by the records module 160 into a records quality check template. In the case of template 500, instances where indicated durations of a record are greater than 8 hours are tabulated for each asset. Other templates may be generated, for example, templates showing instance where duration is less than a given value for each asset, or a group of assets and/or specifying different time periods or ranges.

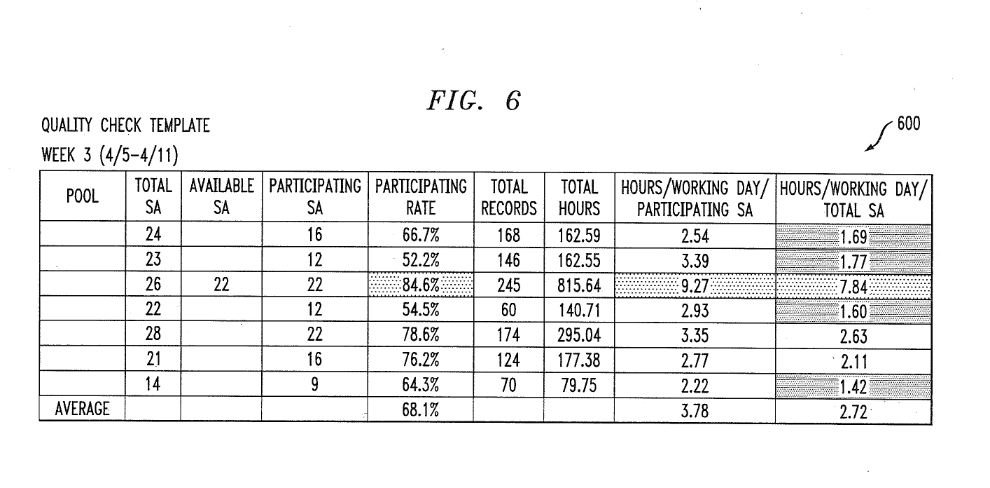

Referring to FIG. 6, an overall quality check template 600 can be generated by combining data from each of the participation, volume and records modules 130, 140 and 160, wherein, as can be seen by the differently shaded areas, the template indicates which areas are not problematic, potentially problematic and problematic. The overall quality check template can be generated by a data combination module 180. The overall quality template 600 is broken up according to groups (pools) of assets, and includes data on the total number of service agents, available service agents, participating service agents, participation rate, total records, total hours, hours per day per agent, and hours per day per total agents in a pool.

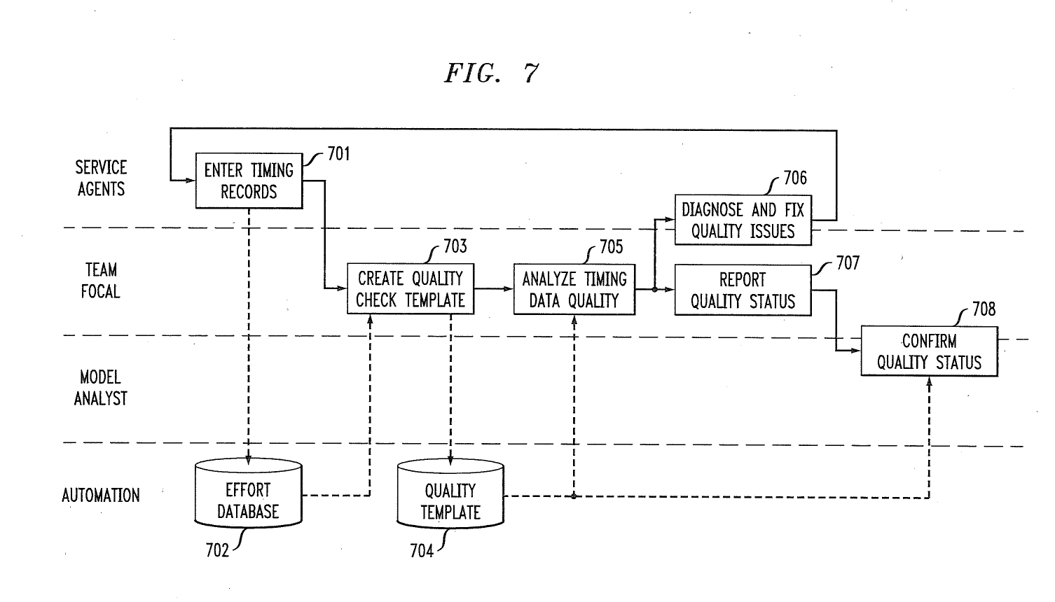

Each of the quality templates 300, 400, 500 and 600 can be provided to a local team member who can review and analyze the results to determine any issues with the data. Referring to FIG. 7, a quality check workflow diagram illustrates assets, such as service agents, entering timing records (block 701), which are input to an effort database 702, which can be located in the effort data module 150. A local team member creates one or more quality check templates (block 703) to reflect data input into the effort database 702, for example, the quality check templates 300, 400, 500 and 600 in unfilled format, and the system 100 processes the data as described above to generate one or more of the templates 300, 400, 500 and 600 in a filled-in format based on the inputted data (block 704). The local team member reviews and analyzes the generated quality templates to determine quality of the data (block 705), and diagnoses and fixes any quality issues (block 706). Fixing quality issues may require reentering timing records as shown by the arrow from block 706 to block 701. The local team member reports quality status (block 707), and a model analyst reviews the local team member's findings to confirm the quality status reported by the local team member (block 708). According to an embodiment, a model analyst can run a service delivery environment simulation model based on the effort data to analyze the service delivery environment and the assets thereof.

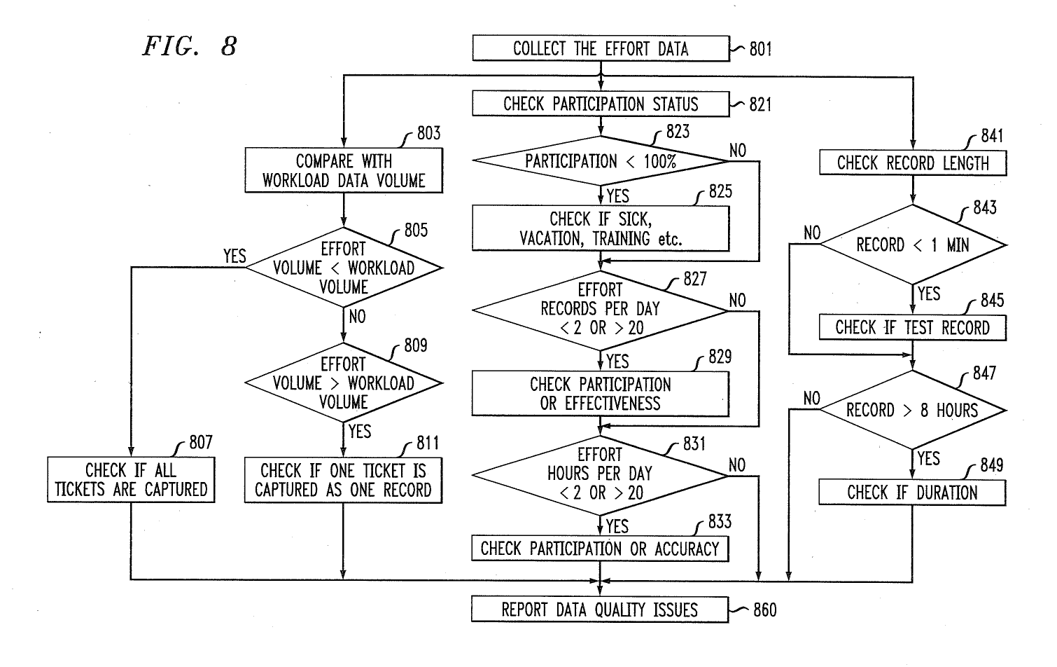

Referring to FIG. 8, which is a flow diagram illustrating a method for ensuring timing study quality in a service delivery environment, according to an embodiment of the present invention, the effort data of the assets is collected at block 801. At block 803, the effort data volume is compared with the workload data volume as described above. At block 805, if the effort data volume is less than the workload volume, it is checked if all of the tickets are being captured by the data collection at block 807, and if the effort data volume is not less than the workload volume, and is greater than the workload volume at block 809, it is checked if one ticket is being captured as one timing entry at block 811. Then, any resulting data quality issues are reported at block 860.

At block 821, a participation status is checked, and if participation status is less than 100% at block 823, a check is performed at block 825 to determine whether any assets can be discounted. After performing the check at block 825, or if participation is not less than 100% at block 823, the method proceeds to block 827, where a query is performed to determine whether the number of records per day is less than 2, or greater than 20. Depending on the asset or system constraints, the numbers in block 827 are not limited to 2 and 20, and may be varied to fit the particular situation. If the answer is yes at block 827, it is checked at block 829 whether there is adequate participation in the data collection or whether the data collection is being effectively performed. After performing the check at block 829, or if the answer is no at block 827, the method proceeds to block 831, where it is queried whether the number of hours per day is less than 2, or greater than 12. Depending on the asset or system constraints, the numbers in block 831 are not limited to 2 and 12, and may be varied to fit the particular situation. If the answer is yes at block 831, then the method proceeds to block 833 where it is checked whether there is adequate participation in the data collection or whether the data collection is accurate. After performing this check at block 833, or if the answer is no at block 831, any resulting data quality issues are reported at block 860.

At block 841, the durations indicated in the records are checked. At block 843, if there are records indicating less than one minute, then it is checked at block 845 whether the records are not actual records, but sample or test records. Depending on the asset or system constraints, the number in block 843 is not limited to one minute, and may be varied to fit the particular situation. After performing the check at block 845, or the answer is no at block 843, a query is performed at block 847 to check whether there are records indicating greater than 8 hours. If the answer is yes at block 847, it is checked at block 849 whether duration without breaks is being recorded instead of actual time spent doing work. Depending on the asset or system constraints, the number in block 847 is not limited to 8 hours, and may be varied to fit the particular situation. After performing the check at block 849, or if the answer is no at block 847, any resulting data quality issues are reported at block 860.

As will be appreciated by one skilled in the art, aspects of the present invention may be embodied as a system, apparatus, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIGS. 1-8 illustrate the architecture, functionality, and operation of possible implementations of systems, methods, and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

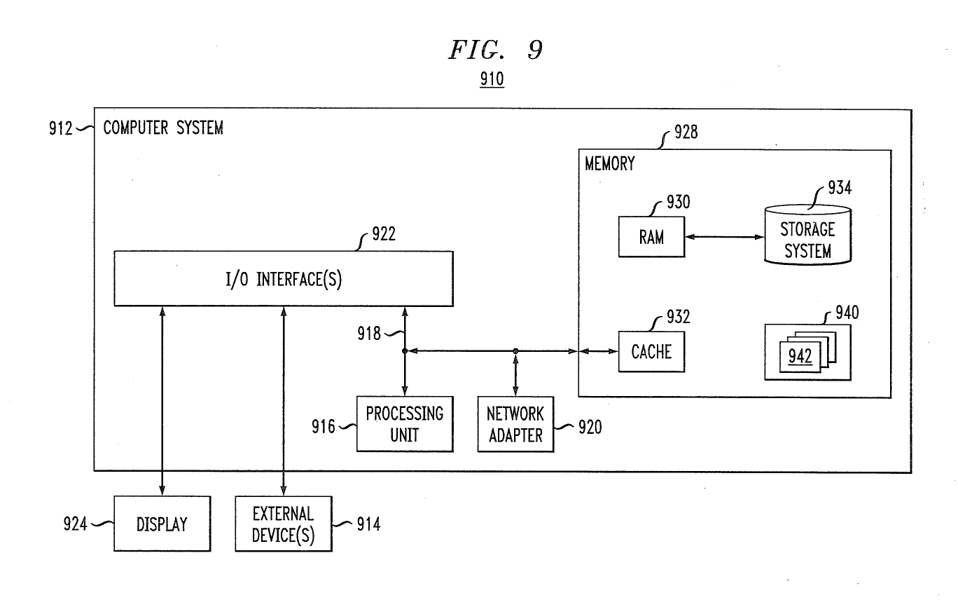

One or more embodiments can make use of software running on a general-purpose computer or workstation. With reference to FIG. 9, in a computing node 910 there is a computer system/server 912, which is operational with numerous other general purpose or special purpose computing system environments or configurations. Examples of well-known computing systems, environments, and/or configurations that may be suitable for use with computer system/server 912 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 912 may be described in the general context of computer system executable instructions, such as program modules, being executed by a computer system. Generally, program modules may include routines, programs, objects, components, logic, data structures, and so on that perform particular tasks or implement particular abstract data types. Computer system/server 912 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 912 in computing node 910 is shown in the form of a general-purpose computing device. The components of computer system/server 912 may include, but are not limited to, one or more processors or processing units 916, a system memory 928, and a bus 918 that couples various system components including system memory 928 to processor 916.

The bus 918 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system/server 912 typically includes a variety of computer system readable media. Such media may be any available media that is accessible by computer system/server 912, and it includes both volatile and non-volatile media, removable and non-removable media.

The system memory 928 can include computer system readable media in the form of volatile memory, such as random access memory (RAM) 930 and/or cache memory 932. The computer system/server 912 may further include other removable/non-removable, volatile/nonvolatile computer system storage media. By way of example only, storage system 934 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 918 by one or more data media interfaces. As depicted and described herein, the memory 928 may include at least one program product having a set (e.g., at least one) of program modules that are configured to carry out the functions of embodiments of the invention. A program/utility 940, having a set (at least one) of program modules 942, may be stored in memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of embodiments of the invention as described herein.

Computer system/server 912 may also communicate with one or more external devices 914 such as a keyboard, a pointing device, a display 924, etc., one or more devices that enable a user to interact with computer system/server 912, and/or any devices (e.g., network card, modem, etc.) that enable computer system/server 912 to communicate with one or more other computing devices. Such communication can occur via Input/Output (I/O) interfaces 922. Still yet, computer system/server 912 can communicate with one or more networks such as a local area network (LAN), a general wide area network (WAN), and/or a public network (e.g., the Internet) via network adapter 920. As depicted, network adapter 920 communicates with the other components of computer system/server 912 via bus 918. It should be understood that although not shown, other hardware and/or software components could be used in conjunction with computer system/server 912. Examples, include, but are not limited to: microcode, device drivers, redundant processing units, external disk drive arrays, RAID systems, tape drives, and data archival storage systems, etc.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1.-9. (canceled)

10. A method for ensuring timing study quality, the method comprising:
determining a level of participation by assets in the timing study;
comparing effort data volume with workload data volume; and
analyzing effort data for a duration for each record, wherein one or more steps of the method are performed by a computer system comprising a memory and at least one processor coupled to the memory.

11. The method of claim 10, further comprising processing the effort data to determine a participation rate, which is a number of assets providing the effort data divided by a total number of assets.

12. The method of claim 11, wherein if the participation rate is less than 100 percent, further comprising identifying those assets which do not provide effort data.

13. The method of claim 10, further comprising processing the effort data to determine a number of task records for each asset over a period of time.

14. The method of claim 13, further comprising identifying if the number of task records is less than a first predetermined value or greater than a second predetermined value.

15. The method of claim 14, wherein if the number of task records is less than the first predetermined value or greater than the second predetermined value, further comprising checking at least one of whether there is a problem with the level of participation or whether there is a problem with the data collection.

16. The method of claim 10, further comprising processing the effort data to determine a number of hours worked by each asset over a period of time.

17. The method of claim 16, further comprising identifying if the number of hours worked is less than a first predetermined value or greater than a second predetermined value, wherein if the number of hours worked is less than the first predetermined value or greater than the second predetermined value, further comprising checking at least one of whether there is a problem with the level of participation or whether there is a problem with the data collection.

18. The method of claim 10, further comprising determining that the workload volume is not equal to the effort data volume.

19. The method of claim 18, wherein if the workload volume is less than the effort data volume, further comprising querying whether more than one timing entry is being generated for one ticket.

20. The method of claim 18, wherein if the workload volume is greater than the effort data volume, further comprising querying at least one of whether all tickets are being captured or whether one record is being generated for more than one ticket.

21. The method of claim 10, further comprising determining if a record duration is less than a first predetermined time or greater than a second predetermined time.

22. The method of claim 21, wherein if the record duration is less than the first predetermined time, further comprising querying whether a record is a test record.

23. The method of claim 21, wherein if the record duration is greater than the second predetermined time, querying whether the duration corresponds to actual time spent doing work.

24.-25. (canceled)
